(19) United States
(12) Patent Application Publication
(10) Pub. No.: US 2022/0234925 A1
(43) Pub. Date: Jul. 28, 2022

(54) SYSTEM AND METHOD FOR PURIFYING DOMESTIC WASTEWATER USING ONE CYCLE A DAY

(71) Applicant: Edmundo GANTER PARGA, Santiago (CL)

(72) Inventor: Edmundo GANTER PARGA, Santiago (CL)

(21) Appl. No.: 17/616,556

(22) PCT Filed: May 28, 2020
(86) PCT No.: PCT/CL2020/050059

§ 371 Date: Dec. 3, 2021

(30) Foreign Application Priority Data
Jun. 6, 2019 (CL) 1559-2019

(51) Int. Cl. C02F 3/12; C02F 3/20; C02F 3/00

(52) U.S. Cl. CPC C02F 3/1263; C02F 3/20; C02F 3/006; C02F 2203/006; C02F 2209/005; C02F 2209/44; C02F 2209/42; C02F 3/1242

(57) ABSTRACT

A system and method for purifying domestic sewage using 1 cycle per day, which reduces constructive complexities, energy demand and avoids the emission of hydrogen sulfide into the environment, the system comprising: a reactor comprising at least two air diffusers located at the bottom of the reactor; a sludge outlet duct and a clarified water outlet duct; a feed pipe connected at one end to a pump submerged inside a pumping chamber and at the other end to a wastewater inlet located at the bottom of the reactor; a programmable logic control; a valve arrangement consisting of four valves connected to a blower, each valve being connected to one of: the sludge outlet duct, the clarified water outlet duct, and the at least two diffusers.

### FIELD OF THE INVENTION

The present invention consists of a plant and method for treatment of domestic wastewater from an individual dwelling, preferably of up to 10 inhabitants operated under a sequential batch system or also known as SBR (Sequential Batch Reactor), with one cycle per day.

### BACKGROUND OF THE INVENTION

In order to treat wastewater from domestic or industrial sources, the organic matter it contains must be substantially reduced. This is done with the action of aerobic bacteria that in the presence of oxygen feed and reproduce themselves thanks to the consumption of organic matter which is transformed into CO2, extracellular polymers and new bacteria, which are called biological sludge.

The biological treatment can be carried out by several methods, but the best results are obtained with cyclic systems using sequential batch reactors (SBR), which produce an effluent of excellent quality and whose water can be used, among other things, for disposal in surface watercourses in compliance with current regulations.

One of the advantages of SBR treatment systems is that all treatment processes occur in the same physical space, but at different time intervals, thus reducing the size of the work and generating a more robust biology, unlike continuous flow systems where all processes occur in separate physical spaces and simultaneously in time.

In addition, the operation of SBR systems has very low energy consumption and can be fully automated through a Programmable Logic Controller, best known for its abbreviation in English as PLC that manages the treatment cycles. This allows wastewater treatment plants to dispense in many cases with the services of an operator.

Another advantage of these systems is that they can maintain a fixed sludge age, which translates into a suitable bacterial ecology and can allow for nitrogen removal. It also allows absorbing large variations in organic matter and flow rate, without affecting its operation, making them more stable and versatile.

On the other hand, the conditions in which the treatment is carried out do not allow the appearance and proliferation of filamentous bacteria, which in many treatment plants represents a serious operating problem.

An example of this type of wastewater treatment plant is disclosed in Patent CL 49,372, where an SBR system is proposed using two concentric tanks, a buffer tank and an SBR reactor, both tanks generating two volumes, an inner one corresponding to the SBR reactor and a volumetric ring outside it, corresponding to the buffer tank. The SBR reactor has in the aeration zone a duct formed by a truncated cone base, in the upper part of which a cylinder emerges, which extends up to the minimum operating height of the SBR reactor.

Said patent also proposes an automatic process for determining the age of the sludge in an SBR reactor, which comprises: extracting excess sludge at the beginning of a day's cycle when the clarification evacuation has been completed; aerating the liquor until reaching the characteristics of mixed liquor; lowering the level of the mixed liquor by 1/10 to 1/12 of the height of the minimum operating level, thus automatically setting the age of the sludge between 10 to 12 days.

A drawback of the system of Patent CL 49,372 is its configuration to operate with 4 or 6 cycles per day, by means of a buffer tank attached to the SBR reactor, where in addition said buffer tank indirectly acts as a septic tank, since every time liquid is passed from the buffer tank to the aerated SBR reactor by program, it is done by means of an air lift pump, which when bubbling the liquid that is in an anaerobic condition, produces the effect of gas stripping, releasing a large amount of hydrogen sulfide, which is very bad smelling and difficult to control, especially in home applications.

A second drawback of the aforementioned system is its complex construction, so its implementation is not economically viable for household applications. For example, to control overflows, the design and use an air suction pump in addition to the three air suction pumps used for loading, unloading and emergency purposes is necessary, which in turn implies designing a fifth solenoid valve (including the aeration valve) that is not available on the market, thus increasing construction and maintenance costs.

On the other hand, some of the blowers commonly used for house plants can work up to a water height of 2 meters, this becoming the maximum possible height to use in such cases. Under these conditions, when faced with increases in flow that exceed the design capacities, or with the need to operate the reactor with one cycle per day, settling and evacuating the excess sludge at night when there is no load and therefore, without a buffer tank, increasing the volume of the reactor is necessary, with the limitation that only the diameter can be increased.

Under these conditions, the situation is quickly reached in which the hourly air flow necessary for the abatement of the organic load does not meet the condition of minimum air flow supplied to ensure that there is no sedimentation of biology inside the reactor

$$( greater than or equal to 3 \frac{{m}^{3}}{{m}^{2} h} ) .$$

When this happens, increasing the air flow rate to reach this requirement is necessary, which, unfortunately, implies an increase in the energy cost.

It is therefore the objective of the present invention to overcome the disadvantages identified in the wastewater treatment plants of the state of the art, by means of a sequential batch system which can operate with one cycle per day, avoiding the use of a buffer tank and therefore the emission of hydrogen sulfide into the environment and at the same time being of simple construction, of low energy demand and economically profitable for single-household applications.

### DESCRIPTION OF THE INVENTION

The present invention operates under the SBR systems principle of operation, which is sufficiently widespread in the state of the art and consists of performing in the same reactor but at separate times, the phases of wastewater loading, aeration in the presence of biology to degrade organic matter, sedimentation of organic matter, evacuation of the clarified liquid and sludge evacuation once a day.

From experience and through continuous research and development by the inventor, it has been determined that the quality of the effluent obtained in single-family plants operated by SBR systems with one cycle per day is of high quality. Then, if it is assumed that between midnight and five o'clock in the morning of each day the water discharges from a house are null or minimal, carrying out the stages of biology sedimentation and clarified discharge is possible in these hours in advantageous way, which ideally should be carried out without the interference of water entering the reactor, in conditions of the greatest possible quietness.

To achieve the above and according to a first aspect of the invention, a system is proposed for purifying domestic sewage using 1 cycle per day comprising:
a reactor comprising at least two air diffusers located at the bottom thereof;
a sludge outlet conduit and a clarified water outlet conduit;
a feed pipe connected at one end to a submerged pump inside a pumping chamber and at the other end to a wastewater inlet located at the bottom of the reactor;
a programmable logic controller;
a valve arrangement consisting of four solenoid valves connected to a blower, each solenoid valve being connected to one of: the sludge outlet line, the clarified water outlet line and one or two diffusers;

Advantageously, the proposed system makes it possible to avoid the use of a buffer tank as those used in the state of the art that receives and accumulates the water during the sedimentation and discharge stages, which, although allowing settling a fraction of solids and separating oils and fats by flotation, acts disadvantageously as a septic tank and generates anaerobic conditions with the consequent production of undesirable odors due to the stripping effect at the time of loading the reactor.

To avoid said undesirable effect, in the present invention the reactor loading is done by means of the submerged pump located in the pumping chamber which is independent of the reactor and which may be, for example, at the outlet of a septic tank. From this chamber, the liquid is pumped into the reactor through the wastewater inlet located at the bottom of the reactor and therefore in the absence of bubbles, avoiding the phenomenon of gas stripping. Additionally, the dissolved gases that enter the reactor with the loaded water are immediately degraded when coming into contact with the biological sludge in the presence of dissolved oxygen.

Another advantage of the proposed system has to do with the use of the aeration equipment made up of the four solenoid valves, which is commercial equipment available on the market, such as the Bonbloc® device of the Bonnel Technologie company, and which in the present invention has been used to replace the blowers traditionally used in household plants which, in some cases, may have a work limitation.

With the solenoid valve arrangement of the proposed system, two of them can be advantageously assigned to feed the at least two air diffusers, with each forming a virtual semicircle inside the reactor. Thus, by aerating the reactor by alternating operation of each diffuser, the condition of complete mixing

$$( amount of air greater than \frac{{m}^{3}}{{m}^{2} h} )$$

will be reached in each virtual semicircle. Then, before the suspended sludge can settle in the semicircle that is not being aerated, the programmable logic controller switches the air to the other diffuser, re-suspending the sludge on the other side and so on.

By means of the above, operating the entire reactor with only 1 cycle per day is possible without the disadvantages of the systems of the state of the art, where the limitation in the water height forces to increase the diameter of the reactor and therefore having to increase the air flow to reach the condition of complete mixing, thus significantly increasing the energetic cost of operation. With the system proposed here, the air used is only that necessary to abate the organic load, so that the energy demand is greatly reduced, thus lowering operating costs. According to one embodiment of the invention, the system also comprises an overflow tube having an opening located at a certain reactor fluid level, said overflow tube being preferably inclined at 60°.

This feature provides the improvement of allowing control in a simpler way than in the systems of the state of the art of the overflows occurring in the reactor due to sudden increases in flow rate, which generally use a suction pump in the reactor and therefore more valves, costs, constructive and operational complexities. Advantageously, by using an inclined overflow pipe such as the one proposed in the present invention, it avoids having to use a suction pump inside the reactor and also prevents the biology present in the sludge inside the reactor from coming out with the effluent, since due to the inclination of the pipe, it will quickly settle at the bottom of the pipe and then slide down the bottom face of the pipe at a higher speed than it would reach in the liquid, an effect known as lamellar settling.

Therefore, in the event of an emergency, the present invention provides an efficient mechanism for the evacuation of excess effluent flow, this ensuring the integrity of the biology inside the reactor.

The present invention further embodies the teachings of Patent CL 49,372 for automatic and accurate sludge age control by locating the inlet of the sludge outlet conduit a fraction below the minimum operating level of the reactor (preferably 120 cm), said fraction of the minimum operating level being equivalent to the age of the sludge desired to be maintained in the reactor.

For sludge to be removed, the sludge must be in a fully mixed condition and in this case at the minimum level. Then, the solenoid valves act by alternating the operation of the diffusers and the suction of the sludge outlet duct, so that in a certain time a fraction of sludge equivalent to the age of the sludge to be kept in the reactor is removed in a controlled manner.

Therefore, according to a second aspect of the invention a method is proposed for purifying domestic wastewater in a system as described above and using 1 cycle per day, wherein each cycle comprises the steps of:
a) loading from a pumping chamber and by means of a submerged pump, wastewater into a reactor for a given time;
b) alternately actuating for a given time two solenoid valves of a valve array connected to a blower, injecting air into at least two diffusers located in the reactor. With this, an alternate aeration is induced that guarantees that the liquor is homogenized, i.e., that it has the characteristics of mixed liquor.
c) carrying out step a) until the pumping chamber is completely emptied and after a certain time, carrying out step b) in parallel;
d) turning off the submerged pump and the blower for a given time, allowing the sedimentation of the sludge to the interior of the reactor;
e) carrying out step b) for a given time to eliminate the nitrogen generated during the sedimentation;
f) carrying out step d) for a given time;
g) discharging clarified water from the reactor by activating the blower and a solenoid valve connected to a clarified water outlet pipe located in the reactor for a given time;
h) executing step b) and g) alternately for a given time;
i) discharging excess sludge from the reactor by activating a solenoid valve and a solenoid valve connected to a sludge outlet line located in the reactor for a given time;
j) carrying out in parallel and for a given time the steps a) and b);
k) carrying out step b) for a given time;
l) carrying out step c);
m) carrying out steps b) and a) alternately for given times;
n) definitively switching off the solenoid valves and the submerged pump.

According to a preferred mode, step i) of excess sludge discharge reduces the level of the mixed liquor by a value of 1/25 of the minimum operating level height in the reactor. This allows setting the sludge age at 10 to 12 days, according to the formula:

$${Q}_{w} = \frac{V}{SRT}$$

Q_{w} is the sludge flow rate evacuated from the aerated reactor; V is the volume of the aerated reactor and SRT is the Sludge Age. The value of 25 days is the value especially recommended because it allows the development of nitrifying biology and it is a digested sludge, with good flocculation and settling properties, while being the optimal sludge age to eventually dry the sludge without producing odors and attracting vectors.

According to a preferred embodiment of the invention, the method further comprises stages for evacuating liquid from the reactor without loss of biology upon an increase in flow rate above the design flow rate, wherein said stages consist of:
(o) detecting an overflow in the pumping chamber or in the reactor;
p) suspending the current cycle;
q) discharging all the wastewater from the pumping chamber to the reactor;
r) carrying out step d);
s) discharging water from the reactor through an overflow tube that has an opening located at a certain reactor fluid level;
t) repeating steps iii) to v) until no overflow is detected in the pumping chamber;
u) restarting the cycle if it should be in progress.

### BRIEF DESCRIPTION OF THE FIGURES

As part of the present invention, the following figures are presented which are representative of the present invention and, therefore, are not to be considered as limiting to the definition of the subject matter claimed.

FIG. 1 illustrates a general schematic of the components of the system of the present invention.

FIG. 2 illustrates a detailed schematic of the components of the sludge outlet and water outlet conduit.

FIG. 3 illustrates a detailed schematic of the valve equipment of the system and its connection to the various components.

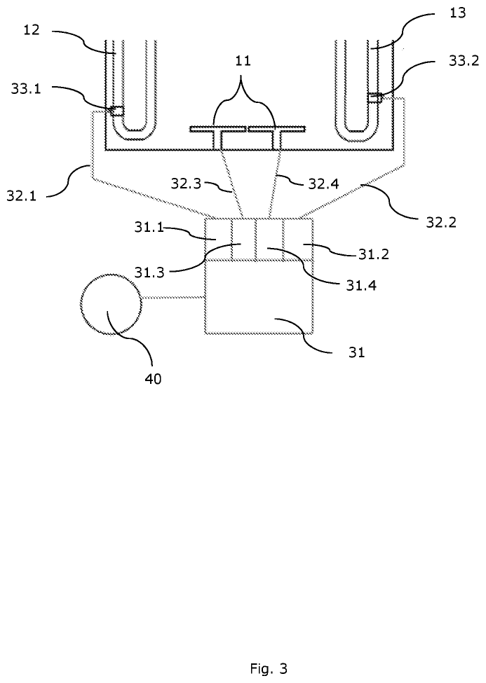

FIGS. 4a to 4c illustrate modalities of the reactor of the invention for different wastewater treatment capacities.

### DETAILED DESCRIPTION OF THE INVENTION

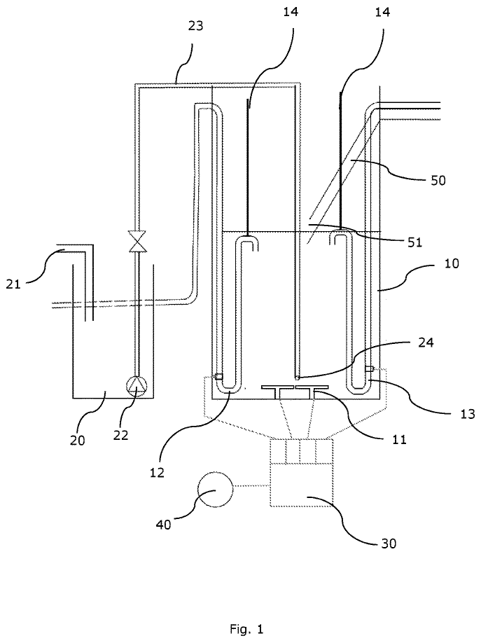

According to the preferred embodiment illustrated in FIG. 1, the system is formed by a reactor 10 consisting of a preferably cylindrical tank which inside and specifically at the bottom thereof, comprises at least two air diffusers 11.

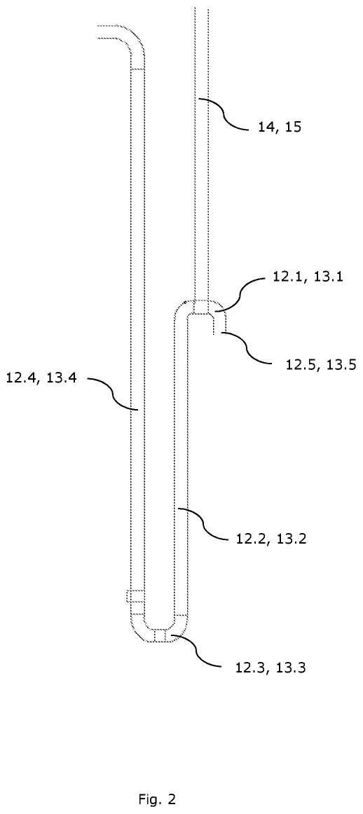

To the interior of the reactor 10 there is also arranged a sludge outlet conduit 12 which, according to an embodiment of the invention, discharges the sludge towards a septic tank (not illustrated) and a clarified water outlet conduit 13 this discharging the clarified water to for example a disinfection plant (not illustrated and optional), which according to the exemplified embodiment are opposite and arranged close to the walls of the reactor 10. Preferably and as can be seen in more detail in FIG. 2, the outlet conduits each consist of PVC pipes, with a first curved portion (12.1, 13.1) located at the top of the reactor and connected to a first vertical portion (12.2, 13.2) extending to the bottom of the reactor and connected to a second curved portion (12.3, 13.3). Said second curved portion is connected to a second vertical portion (12.4, 13.4) which extends to the outside of the reactor, above a maximum water level.

The first curved portion (12.1, 13.1) has an open end (12.5, 13.5) which configures an inlet for the fluid flowing through each conduit. Furthermore, said curved portion is connected with a respective support (14, 15) configured to hold each conduit and keep it positioned inside the reactor, which preferably consists of a PVC pipe.

Referring back to FIG. 1, it is shown that the system comprises a pumping chamber 20 consisting of a small drum which receives the domestic wastewater by means of an inlet pipe 21 and which comprises in its interior a submerged pump 22 configured to pump the stored wastewater into the reactor 10, by means of a feed pipe 23. The feed pipe 23 flows into the bottom of the reactor 10, preferably into a wastewater inlet 24.

According to a preferred embodiment of the invention, the pumping chamber consists of a PVC drum with lid (sealed) and with a capacity of preferably 200 L.

As can be seen in FIG. 1, the system comprises a valve arrangement 30, consisting of 4 solenoid valves connected to a blower 40. Furthermore as illustrated in more detail in FIG. 2, a first valve 31.1 is connected by means of a first hose 32.1 to the sludge outlet conduit 12, preferably by means of a first starting collar 33.1.

A second valve 31.2 is connected via a second hose 32.2 to the clarified water outlet conduit 13, preferably via a second starting collar 33.2. A third valve 31.3 is connected by means of a third hose 32.3 to at least one diffuser 11, while a fourth valve 31.4 is connected by means of a fourth hose 32.4 to at least another diffuser 11.

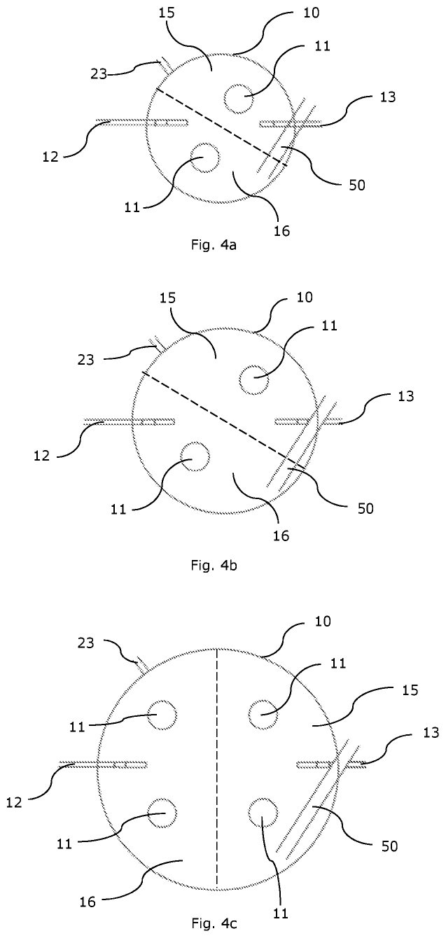

According to the embodiment of the invention where four diffusers are used (see FIG. 4c), the third valve 31.3 is connected to a flow divider and then by means of two hoses to each of the diffusers 11 of the first pair of diffusers. Similarly, the fourth valve 31.4 is connected to a flow divider and then by means of two hoses to each of the diffusers 11 of the second pair of diffusers.

The size of the reactor 10 and the number of diffusers 11 will depend on the treatment capacity required by the system, for example according to the number of people living in the place where the plant will be installed. Accordingly, FIGS. 4a to 4c show three top views of the reactor 10 with preferred arrangements depending on the treatment capacity and whose characteristics are summarized in the table below:

| | | Reactor's | Reactor's | |
|---|---|---|---|---|
| | | height | diameter | No of |
| FIG. | Capacity | (m) | (m) | diffusers |
| 1a | 4 persons | 2.00 | 1.20 | 2 |
| 1b | 6 persons | 2.00 | 1.50 | 2 |
| 1c | 10 persons | 2.00 | 1.95 | 4 |

In the embodiment illustrated in FIGS. 4a and 4b, designed for a capacity of 4 and 6 persons respectively, the only thing that varies is the diameter of the reactor 10, the spacing of the diffusers acting in each virtual semicircle (15, 16) of the reactor and the size of the blower feeding those diffusers.

In the case of FIG. 4c, the diffusers 11 are distributed in pairs within each virtual semicircle (15, 16), so that each pair of diffusers 11 is fed by the same solenoid valve, unlike the embodiments of FIGS. 4a and 4b, where each diffuser 11 is fed by a separate solenoid valve.

The proposed system, in order to operate in safe terms having a reduced volume, is equipped with an overflow detection means that allows the evacuation of excess water from inside the reactor 10 without losing biology. To perform said evacuation and according to FIG. 1, the system comprises an overflow tube 50 located at a desired maximum level of fluid in the tank and which prevents a sudden increase in flow rate from exceeding said maximum level. Said overflow tube 50 projects into the reactor 50 up to the minimum operating level and with a slope preferably of 60° to prevent loss of the biology present in the reactor. Furthermore, at its end to the interior of the reactor it has an opening 51 in chamfer type cut to prevent the entry of bubbles. Preferably, the overflow tube 50 has a diameter of 75 mm.

To perform this emergency operation, either the pumping chamber 20 or the reactor 10 comprises an overflow sensor (not illustrated) which when activated, the programmable logic control acts by suspending the cycle in progress. A set sedimentation time is then initiated. Subsequently and through the overflow pipe 50 whose opening 51 is at a higher suction point than the open end 13.5 of the clarified water conduit 13, the excess water is evacuated from inside the reactor to a disinfection plant, an operation that has very little chance of entraining biology, since the suction point is already in a zone of clarified liquid and its inclination produces the effect of lamellar settling, that is, it allows the biology to decant inside the reactor faster than it would tend to flow out of the tube towards the outside of the reactor.

This emergency operation could be extended for as long as necessary until the level sensor is deactivated. When the latter has happened, the scrubbing cycle is resumed if it is on schedule.

### NUMERICAL REFERENCES

10 Reactor
11 Diffuser
12 Sludge outlet duct
12.1 First curved portion
12.2 First vertical portion
12.3 Second curved portion
12.4 Second vertical portion
12.5 Open end
13 Clarified water outlet duct
13.1 First curved portion
13.2 First vertical portion
13.3 Second curved portion
13.4 Second vertical portion
13.5 Open end
14 Support
15 First virtual semicircle
16 Second virtual semicircle
20 Pumping chamber
21 Inlet pipe
22 Submerged pump
23 Feed pipe
24 Wastewater inlet
30 Valve arrangement
31.1 First valve
31.2 Second valve
31.3 Third valve
31.4 Fourth valve
32.1 First hose
32.2 Second hose
32.3 Third hose
32.4 Fourth hose
33.1 First starter collar
33.2 Second starter collar
40 Blower
50 Overflow tube

1. A system for purifying domestic sewage using 1 cycle per day, which reduces construction complexities, energy demand and avoids the emission of hydrogen sulfide into the environment, comprising the system:
a reactor (10) comprising at least two air diffusers (11) located at the bottom thereof;
a sludge outlet duct (12) and a clarified water outlet duct (13);
a feed pipe (23) connected at one end to a submerged pump (22) inside a pumping chamber (20) and at the other end to a waste water inlet (24) of the reactor (10);
a programmable logic controller;
wherein the wastewater inlet (24) is located at the bottom of the reactor and in that the system further comprises:
a valve arrangement (30) consisting of four valves (31.1, 31.2, 31.3, 31.4) connected to a blower (40), each valve (31.1, 31.2, 31.3, 31.4) being connected to one of: the sludge outlet duct (12), the clarified water outlet duct (13) and one or two diffusers (11).

2. The system according to claim 1, wherein it further comprises an overflow pipe (50) having an opening (51) located at a minimum operating level of the reactor (10), said overflow pipe (50) being inclined.

3. The system according to claim 1, wherein one end of the overflow tube (50) which is inside the reactor (10) has an opening (51) in chamfer type cut.

4. The system according to claim 2, wherein the overflow tube (50) is inclined at 60°.

5. The system according to claim 1, wherein the sludge outlet pipe (12) empties into a septic tank.

6. The system according to claim 2, wherein the clarified water outlet conduit (13) and the overflow pipe (50) discharge to a disinfection plant.

7. The system according to claim 1, wherein the outlet conduits (12, 13) each consist of PVC pipes, with a first curved portion (12.1, 13.1) located at the top of the reactor and connected to a first vertical portion (12.2, 13.2) extending to the bottom of the reactor and connected to a second curved portion (12.3, 13.3), wherein said second curved portion is connected to a second vertical portion (12.4, 13.4) which extends to outside of the reactor (10), above a maximum water level.

8. The system according to claim 7, wherein said first curved portion (12.1, 13.1) has an open end (12.5, 13.5).

9. The system according to claim 1, wherein the pumping chamber (20) is connected to an inlet pipe (21) for domestic wastewater.

10. The system according to claim 1, wherein the connection between each valve (31.1, 31.2, 31.3, 31.4) and one of the sludge outlet pipe (12), the clarified water outlet pipe (13) and the at least two diffusers (11), is by means of hoses (32.1, 32.2, 32.3, 32.4).

11. The system according to claim 1, wherein the reactor (10) comprises two diffusers (11), each being connected to a valve (31.2, 31.3).

12. The system according to claim 1, wherein the reactor (10) comprises two pairs of diffusers (11), each pair being operated by a valve (31.3, 31.4).

13. A method for purifying domestic sewage in a system as defined in claim 1, using 1 cycle per day, wherein each cycle comprises the steps of:
a) loading from a pumping chamber (20) and by means of a submerged pump (22), sewage water into a reactor (10) for a given time;
b) actuating alternately for a given time two solenoid valves (31.3, 31.4) of a valve arrangement (30) connected to a blower (40), injecting air into at least two diffusers (11) located in the reactor (10);
c) carrying out step a) until the pumping chamber (20) is completely emptied and from a given time carrying out step b) in parallel;
d) turning off the submerged pump (22) and the solenoid valves (31.1, 31.2) for a given time;
e) carrying out step b) for a given time;
f) carrying out step d) for a given time;
g) discharging clarified water from the reactor (10) by activating for a given time a solenoid valve (31.2) connected to a clarified water outlet line (13) located in the reactor (10);
h) carrying out the step b) and g) alternately for a given time;
i) discharging sludge from the reactor (10) activating a solenoid valve (31.1) connected to a sludge outlet conduit (12) located in the reactor (10) for a given time;
j) carrying out in parallel and for a given time the steps a) and b);
k) carrying out step b) for a given time;
l) carrying out step c);
m) carrying out steps b) and a) alternately for given times;
n) definitively switching off the solenoid valves (31.1, 31.2, 31.3, 31.4) and the submerged pump (20).

14. The method according to claim 13, wherein the step i) comprises discharging sludge at a value of 1/25 of the height of the minimum operating level in the reactor (10).

15. The method according to claim 13, wherein it further comprises the steps of:
o) detecting an overflow in the pumping chamber (20) or in the reactor (10);
p) suspending the current cycle;
q) discharging all the wastewater from the pumping chamber (20) into the reactor (10);
r) carrying out step d);
s) discharging water from the reactor through an overflow pipe (50) having an opening (51) located at a minimum operating level of the reactor (10);
t) repeating steps q) to s) until no overflow is detected in the pumping chamber (20) or in the reactor;
u) resuming the cycle in case it should be in progress.
